(19) United States
(12) Patent Application Publication
(10) Pub. No.: US 2025/0337045 A1
(43) Pub. Date: Oct. 30, 2025

(54) Battery Heat Exchanger

(71) Applicant: LG ELECTRONICS INC., Seoul (KR)

(72) Inventors: Jongoh LEE, Seoul (KR); Kangseok MOON, Seoul (KR); Joongnyon KIM, Seoul (KR); Jiwon YU, Seoul (KR); Seonghun KWON, Seoul (KR)

(73) Assignee: LG ELECTRONICS INC., Seoul (KR)

(21) Appl. No.: 18/580,777

(22) PCT Filed: Oct. 12, 2021
(86) PCT No.: PCT/KR2021/013963

§ 371 Date: Aug. 19, 2024

(30) Foreign Application Priority Data
Jul. 20, 2021 (KR) 10-2021-0094795

(51) Int. Cl. H01M 10/6568; B60L 58/26; H01M 10/613; H01M 10/625; H01M 10/647; H01M 10/6554; H01M 50/211; H01M 50/249

(52) U.S. Cl. CPC H01M 10/6568; H01M 10/613; H01M 10/625; H01M 10/647; H01M 10/6554; H01M 50/211; H01M 50/249; B60L 58/26; H01M 2220/20

(57) ABSTRACT

A battery heat exchanger comprises; an upper plate which dissipates heat from a battery; a lower plate having a bonded body portion bonded to the bottom surface of the upper plate and a flow path body portion forming a flow path through which a cooling fluid is guided; an inlet body which guides the cooling fluid to the flow path; an outlet body through which the cooling fluid after passing through the flow path is discharged; and a plurality of columns which protrude from at least one of the upper plate and the lower plate to be located in the flow path and each have the outer circumference spaced apart from the side wall of the flow path body portion, wherein the plurality of columns are formed along the flow path, at least one of the plurality of columns is an elliptical column having an elliptical cross-sectional shape, and the elliptical pillar is lengthily formed in the lengthwise direction of the flow path.

### TECHNICAL FIELD

The present invention relates to a heat exchanger, and more specifically, to a battery heat exchanger capable of dissipating heat from a battery.

### BACKGROUND ART

The vehicle may be equipped with a battery that supplies electricity to the electric motor, a motor controller that controls the electric motor, etc.

The battery installed in vehicles can be charged from renewable power sources or charger and the battery can supply power to the electric motor when the vehicle is running.

The performance of a battery can be largely determined by the temperature of the battery, and the temperature of the battery during rises charging and discharging.

As the battery continues to be used, electrolyte decomposition occurs, which reduces battery performance and gradually shortens lifespan.

A battery may comprise a plurality of battery modules, and it is desirable to manage the plurality of battery modules to minimize temperature differences between the plurality of battery modules.

A battery cooling device may be installed in the vehicle to cool the battery module to prevent overheating of the battery module and maintain the performance of the battery module.

### DISCLOSURE OF THE INVENTION

### Technical Problem

The purpose of the present invention is to provide a battery heat exchanger that can maximize heat generated from a battery cell bundle by using an elliptical pillar and minimize temperature differences between a plurality of battery cells.

### Technical Solution

The battery heat exchanger according to this embodiment comprises an upper plate through which heat from the battery is dissipated; a lower plate having a joint body portion joined to a bottom surface of the upper plate and a flow path body portion forming a flow path through which cooling fluid is guided; an inlet body guiding cooling fluid to the flow path; an outlet body which cooling fluid passing through the flow path flows out; and a pillar positioned in the flow path, protruding from at least one of the upper plate or the lower plate, and having an outer circumference spaced apart from a side wall of the flow path body portion. A plurality of pillars is formed along the flow path. At least one of the plurality of pillars is an oval pillar with an oval cross-sectional shape. The oval pillar is formed to be long in the longitudinal direction of the flow path.

The pillar may protrude from the bottom surface of the upper plate and may be in contact with a lower plate portion of the lower plate.

The pillar may protrude from a lower plate portion of the lower plate and may be in contact with the bottom surface of the upper plate.

The pillar may protrude from the lower surface of the upper plate and may have a lower end spaced apart from a lower plate portion of the lower plate.

An aspect ratio of the oval pillar may be greater than 1 and less than or equal to 1.1.

At least one of the plurality of pillars may be a porous metal foam.

### Advantageous Effects

According to this embodiment, pressure loss can be minimized by the oval pillar disposed in the flow path, and heat from the battery can be dissipated more quickly.

### BRIEF DESCRIPTION OF THE DRAWINGS

FIG. 1 is a perspective view showing a battery heat exchanger according to this embodiment;

FIG. 2 is an exploded perspective view of the battery heat exchanger according to this embodiment;

FIG. 3 is a plan view showing the inside of the battery heat exchanger according to this embodiment;

FIG. 4 is a cross-sectional view taken along line A-A of FIG. 3;

FIG. 5 is a view showing the drag coefficient according to the aspect ratio of the pillar of the battery heat exchanger according to this embodiment;

FIG. 6 is a first modified example of the heat exchanger shown in FIG. 4;

FIG. 7 is a second modified example of the heat exchanger shown in FIG. 4;

FIG. 8 is a plan view showing the interior of a third modified example of a battery heat exchanger according to this embodiment;

FIG. 9 is a plan view showing the interior of a fourth modified example of a battery heat exchanger according to this embodiment.

FIG. 10 is a plan view showing the interior of a fifth modified example of a battery heat exchanger according to this embodiment.

### MODE FOR CARRYING OUT THE INVENTION

Hereinafter, detailed embodiments will be described in detail with reference to the accompanying drawings.

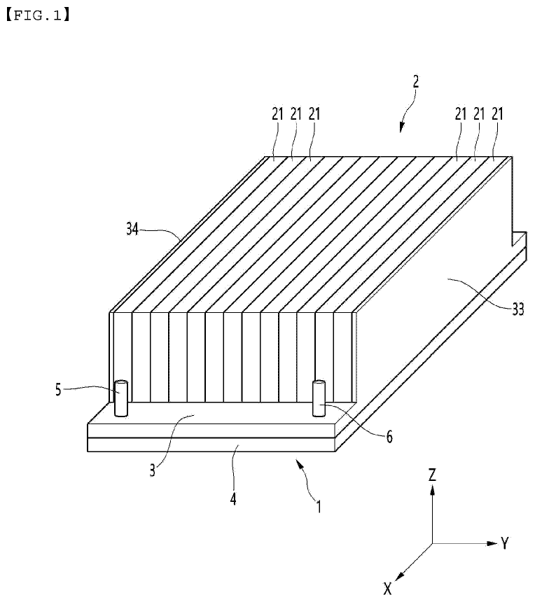

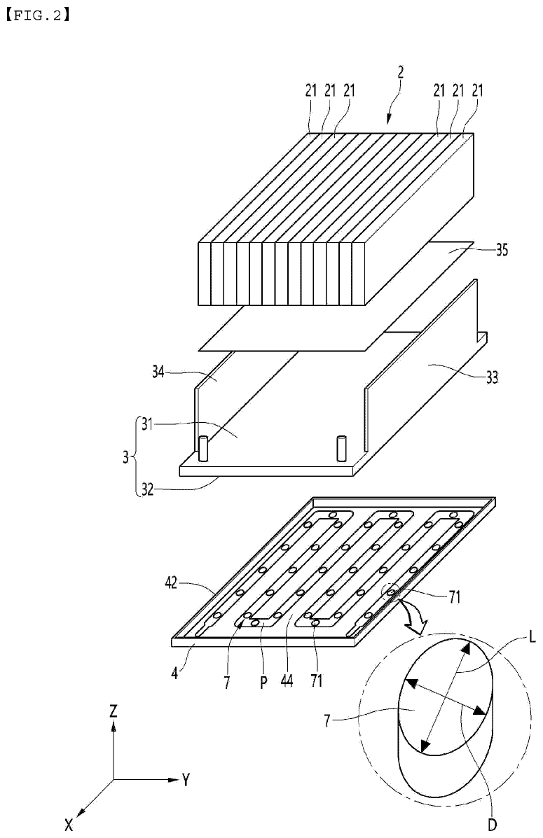

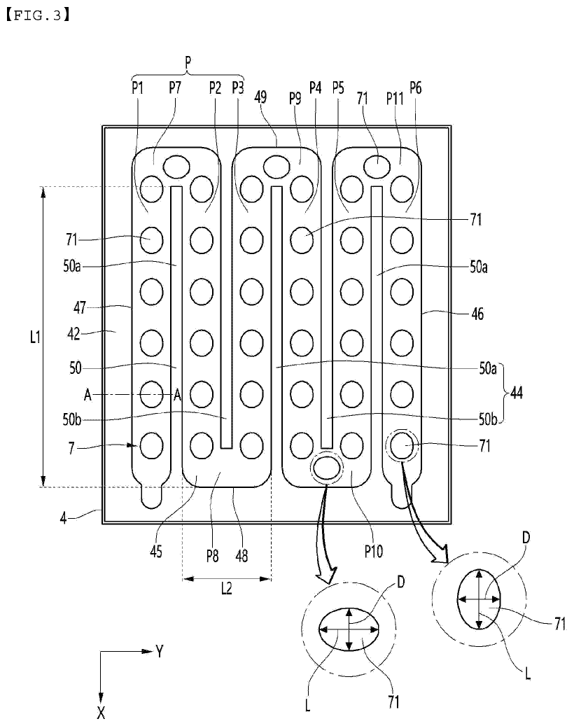

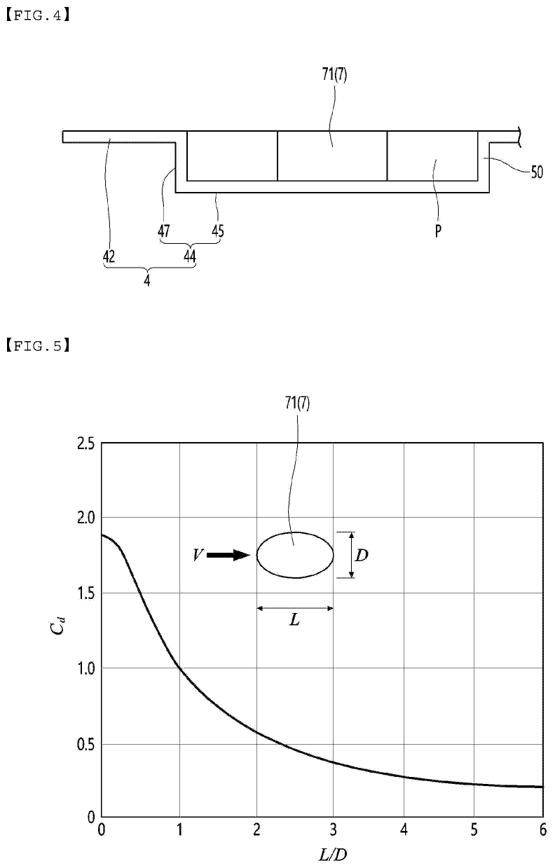

FIG. 1 is a perspective view showing a battery heat exchanger according to this embodiment, FIG. 2 is an exploded perspective view of the battery heat exchanger according to this embodiment; and FIG. 3 is a plan view showing the inside of the battery heat exchanger according to this embodiment; and FIG. 4 is a cross-sectional view taken along line A-A of FIG. 3.

The battery heat exchanger 1 may be a heat exchanger capable of dissipating heat from the battery 2, and comprises an upper plate 3, a lower plate 4, an inlet body 5, an outlet body 6, and a pillar. (7).

An example of the battery 2 may be a battery for an electric vehicle, and an efficient cooling method for the battery 2 is required to minimize the increase in temperature of the battery 2, which causes a decrease in the performance of the battery 2, and requires a cooling structure that facilitates assembly of a bundle of the battery cell 21 and the battery heat exchanger 1.

The battery cell 21 may be a battery pouch with cells built into the pouch, and a bundle of such battery cells 21 will be defined and described as the battery 2.

Battery cells 21 may be stacked in the left and right direction Y. A bundle of battery cells 21 may be placed on the upper side of the battery heat exchanger 1.

The battery heat exchanger 1 may be a cooler or a cooling heat exchanger capable of cooling the battery 2, and may absorb heat from the battery 2 using a cooling fluid such as water.

Various examples of the cooling fluid may be applied, one example may be water, another example may be a mixture of water and ethylene glycol. The cooling fluid may be a mixture of 50% water and 50% ethylene glycol.

If the cooling fluid comprises water, the battery heat exchanger 1 may be a water-cooled heat exchanger. The battery heat exchanger 1 may be connected to an external pump, and the cooling fluid pumped from the pump may absorb heat from the battery 2 while passing through the battery heat exchanger 1.

Hereinafter, the configuration of the battery heat exchanger 1 will be described.

The upper plate 3 may be in thermal contact with the battery 2, and heat of the battery 2 may be transferred to the upper plate 3.

The battery heat exchanger 1 can efficiently dissipate the heat of the battery 1 through heat transfer through the lower portion of the bundle of the battery cell 21.

The upper surface 31 of the upper plate 3 may be a seating surface on which the battery 1 is seated. The bottom surface 32 of the upper plate 3 may be a flow path forming surface that forms a flow path P, which will be described later. The bottom surface 32 of the upper plate 3 may be a flow path cover surface that covers the flow path P from the upper side of the flow path P. The bottom surface 32 of the upper plate 3 may be a joint surface joined to the lower plate 4.

The upper plate 3 may be provided with side plates 33 and 34. The side plates 33 and 34 may comprise a left plate 33 located next to the left side of the battery 1 and a right plate 34 located next to the right side of the battery 1.

The left plate 33 and the right plate 34 may be spaced apart in the left and right direction Y, and the battery 1 may be inserted between the left plate 33 and the right plate 34.

The upper plate 3 may be a frame formed overall in a ‘U’ shape. The upper plate 3 may be made of aluminum.

The upper surface 31 of the upper plate 3 may be in direct contact with the battery 1, or may be in thermal contact with the battery 1 through a separate heat transfer member 35.

The heat transfer member 35 may be disposed between the upper surface 31 of the upper plate 3 and the battery 1. The heat transfer member 35 may receive heat from the battery 1, and the heat to be transferred to the heat transfer member 35 may be conducted to the upper plate 3.

An example of the heat transfer member 35 may be a thermal pad such as thermal resin.

A thermal pad such as thermal resin may be positioned between the upper plate 3 and the battery 2 when assembled.

The lower plate (4) may be disposed below the upper plate (3) and may support the upper plate (3). The lower plate 4 may be joined to the bottom surface of the upper plate 3 by brazing or the like. The battery heat exchanger 1 can minimize the number of portions and can be easily assembled.

The lower plate 4 may comprise a joint body portion 42 and a flow path body portion 44.

The joint body portion 42 may be joined to the bottom surface 32 of the upper plate 3.

The joint body portion 42 may comprise an edge of the lower plate 4 and may have an overall square frame shape. The joint body portion 42 may be joined to the upper plate 3 by welding or brazing, and the width of the joint body portion 42 is preferably be 7 mm or more.

The flow path body portion 44 may form a flow path P through which cooling fluid is guided. The flow path body portion 42 may be an inner region of the joint body portion 42.

The flow path body portion 44 comprises a lower plate portion 45, a left wall 46, a right wall 47, a front wall 48, and a rear wall 49, the left wall 46, the right wall 47, the front wall 48, and the rear wall 49 extends upward from the lower plate portion 45, a flow path P may be formed on the upper side of the lower plate portion 45.

The flow path body portion 44 may comprise a flow path side wall 50. At least one flow path side wall 50 may be disposed between the left wall 46 and the right wall 47.

The flow path side wall 50 may be spaced apart from each of the left wall 46 and the right wall 47 in the left and right direction Y. A plurality of flow path side wall 50 may be formed between the left wall 46 and the right wall 47, and the plurality of flow path side walls 50 may be spaced apart in the left and right direction Y.

The flow path P may be formed in a shape that minimizes pressure loss. The flow path P may be formed in a zigzag shape on the lower plate 4. The plurality of flow path side walls 47 may comprise a first flow path side wall 50a and a second flow path side wall 50b.

The front end of the first flow path side wall 50a may be connected to the front wall 48, and the rear end of the first flow path side wall 50a may be spaced apart from the rear wall 49 in the front and rear direction X.

The front end of the second flow path side wall 50b may be spaced apart from the front wall 48 in the front and rear direction X, and the rear end of the second flow path side wall 50b may be connected to the rear wall 49.

The first flow path side wall 50a and the second flow path side wall 50b may be alternately disposed between the left wall 44 and the right wall 47.

The lower plate 4 can be made of sheet metal through a press, and manufacturing the lower plate 4 can be simple.

The flow path P may be formed to minimize the temperature difference of the bundle of battery cells 21.

The width of the flow path P may be 150 mm to 200 mm. The height of the flow path P may be 2 mm to 2.5 mm.

The flow path P may comprise a plurality of unit flow paths P1, P2, P3, P4, P5, P6. A plurality of unit flow paths P1, P2, P3, P4, P5, P6 may be parallel. A plurality of unit flow paths P1, P2, P3, P4, P5, P6 may be formed to be long in the front and rear direction X and may be separated from each other in the left and right direction Y.

The length of the plurality of unit flow paths P1, P2, P3, P4, P5, P6 in the front and rear direction X may be longer than the width in the left and right direction Y.

The flow path P may comprise connecting flow paths P7, P8, P9, P10 and P11. The connection flow paths P7, P8, P9, P10 and P11 can connect adjacent unit flow paths P1, P2, P3, P4, P5, P6. The connection flow paths P7, P8, P9, P10 and P11 may be formed long in the left and right direction Y.

The length of the plurality of connection flow paths P7, P8, P9, P10 and P11 in the left and right directions Y may be longer than the width in the front and rear directions X.

The length L1 of the unit flow paths P1, P2, P3, P4, P5, P6 is longer than the length L2 of the connection flow paths P7, P8, P9, P10 and P11.

The flow path P may have the same or different inlet and outlet directions depending on the number of unit flow paths P1, P2, P3, P4, P5, P6.

If the number of unit flow paths P1, P2, P3, P4, P5, P6 is even, the inlet and outlet directions may be the same, and a plurality of battery heat exchangers 1 may be easily connected in parallel.

If the number of unit flow paths P1, P2, P3, P4, P5, P6 is odd, the inlet and outlet directions may be different, and a plurality of battery heat exchangers 1 may be easily connected in series.

The inlet body 5 may guide the cooling fluid W to the flow path P, and the cooling fluid W passing through the flow path P may flow out to the outlet body 6.

The pillar 7 may protrude from at least one of the upper plate 3 and the lower plate 4 to be positioned in the flow path P.

An example of the pillar 7 may protrude upward from the lower plate 45 of the lower plate 4 and contact the bottom surface 32 of the upper plate 3. Another example of the pillar 7 may protrude downward from the bottom surface 32 of the upper plate 3 and contact the lower plate portion 42 of the lower plate 4.

The outer circumference of the pillar 7 may be spaced apart from the side walls 46, 47, and 50 of the flow path body portion 44.

A plurality of pillars 7 may be formed along the flow path P. A plurality of pillars P may be arranged in a row along the flow path P.

At least one of the plurality of pillars 7 may be a pillar 71 having an oval cross-sectional shape. All of the plurality of pillars 7 formed in the flow path P may be oval pillars 71. That is, a plurality of oval pillars 71 may be provided in the flow path P.

The oval pillar 71 is located in the flow path P and serves as a heat dissipation fin and can increase the heat transfer rate by inducing flow mixing.

The oval pillar 71 can be placed on the lower portion of the upper plate 3 through press processing or heat bonding at high temperature.

The oval pillar 71 can connect the upper plate 3 and the lower plate 4, and the oval pillar 71 can minimize the deformation of the battery heat exchanger 1 due to the weight of the bundle of the battery cell 21.

The oval pillar 71 may be formed to be long in the length direction L1, L2 of the flow path P.

The length L in the front and rear direction X of the oval pillar 71 located in the long unit flow paths P1, P2, P3, P4, P5, P6 in the front and rear direction X can be longer than the width D in the left and right directions Y. The oval pillars 71 disposed in the unit flow paths P1, P2, P3, P4, P5, P6 may have a long axis in the front and rear direction X and a short axis in the left and right direction Y.

The oval pillars 7 located in the connection flow paths P7, P8, P9, P10 and P11 long in the left and right directions Y have a length L in the left and right directions Y longer than the width D in the front and rear directions Y. The connection flow paths P7, P8, P9, P10, and P11 may have a long axis in the left and right direction Y and a short axis in the front and rear direction X.

Heat generated from the bundle of battery cells 21 may be transferred to the upper plate 3 by conduction. The heat transferred to the upper plate 3 may be transferred to the cooling fluid through convection by the cooling fluid passing through the flow path P and conduction through the oval pillar 71.

The passage P as described above can maximize convective heat transfer, and the oval pillar 71 disposed in the passage P acts like a heat dissipation fin, increasing the heat transfer rate and helping with efficient heat dissipation.

When the long axis of the oval pillar 71 is parallel to the flow direction of the cooling fluid, flow separation and vortex generation can be minimized, and pressure loss can be minimized.

FIG. 5 is a view showing the drag coefficient according to the aspect ratio of the pillar of the battery heat exchanger according to this embodiment.

The aspect ratio L/D of the oval pillar 71 may be greater than 1 and less than or equal to 1.1.

The aspect ratio L/D may be defined as the longitudinal length L of the oval pillar 71 divided by the unidirectional length D of the oval pillar 71.

If the aspect ratio L/D is 1, the cross-sectional shape of the pillar is circular, and if the aspect ratio L/D exceeds 1, it is oval.

When the oval pillar 71 is located in the flow path P, the oval pillar 71 may act as resistance, and the flow path resistance due to the oval pillar 71 may vary depending on the aspect ratio L/D.

The drag coefficient Cd when the cross-sectional shape of the pillar is oval is less than the drag coefficient Cd when the cross-sectional shape of the pillar is circular L/D=1, and the battery heat exchanger (1) is an oval pillar 71, the flow resistance is less than in the case of a circular pillar.

As shown in FIG. 5, the larger the aspect ratio L/D, the smaller the drag coefficient Cd, and this oval pillar 71 can reduce pressure loss.

Assuming that the output of the pump is the same, the oval pillar 71 can increase the flow rate of the battery heat exchanger (1) compared to the circular pillar, and if it is assumed that the flow rate is the same, it can increase pump efficiency compared to the circular pillar.

In the battery heat exchanger 1, all pillar 7 may be oval pillar 71.

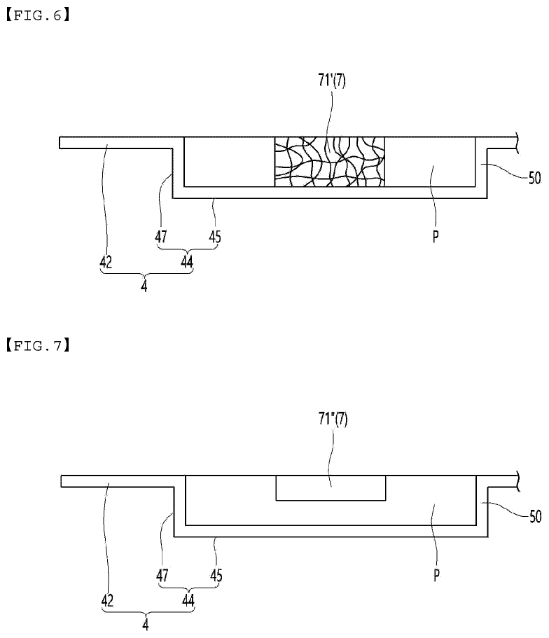

FIG. 6 is a first modified example of the heat exchanger shown in FIG. 4.

At least one of the plurality of pillars 7 of the battery heat exchanger 1 may be a porous metal material, for example, a porous metal foam 71′, as shown in FIG. 6.

The configuration and operation other than the porous metal form 71′ are the same as those of the oval pillar 71 of the present embodiment shown in FIGS. 2 to 4, and detailed descriptions of the same configuration and operation as those of the present embodiment are omitted.

When the cooling fluid passes through the flow path P, a portion of the cooling fluid may penetrate the porous metal form 71′.

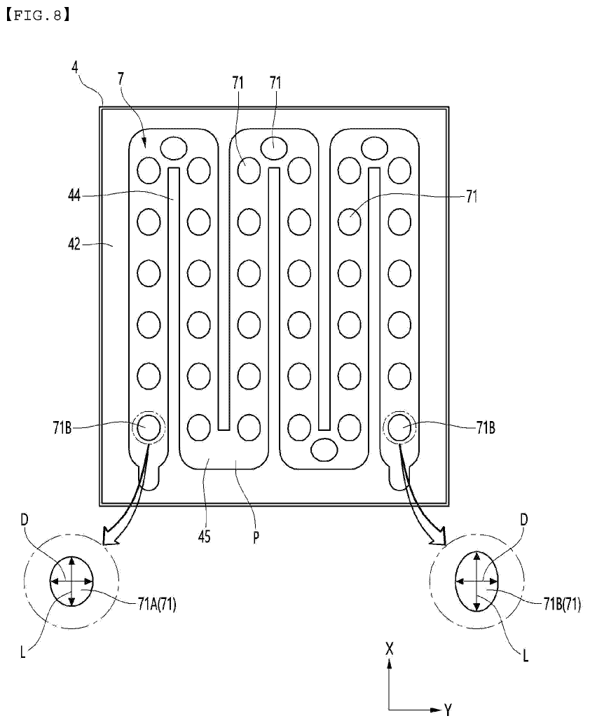

FIG. 7 is a second modified example of the heat exchanger shown in FIG. 4.

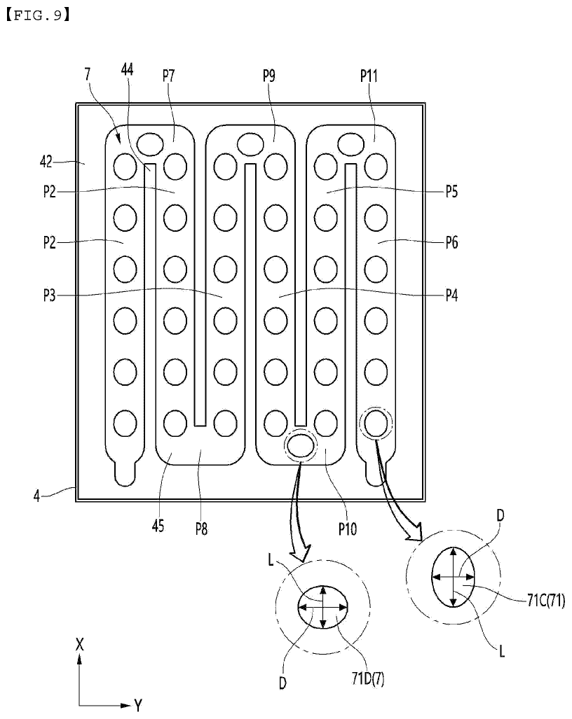

The pillar 7 shown in FIG. 8 may be an oval pillar 71″ in cross-sectional shape, and the oval pillar 71″ protrudes from the lower surface 32 of the upper plate 3 and has a lower end spaced apart from the lower plate portion 45 of the lower plate 4.

Other than the lower end of the oval pillar 71″ being spaced apart from the lower plate portion 45 of the lower plate 4, the configuration and operation are the same as the oval pillar 71 of the present embodiment shown in FIGS. 2 to 4. Detailed descriptions of the same configuration and operation as in the embodiment are omitted.

FIG. 8 is a plan view showing the interior of a third modified example of a battery heat exchanger according to this embodiment.

The plurality of oval pillars 71 comprise an inlet oval pillar 71A closer to the inlet body 5 among the inlet body 5 and the outlet body 6, and an outlet oval pillar 71B closer to the outlet body 6 among the inlet body 5 and the outlet body 6

The plurality of oval pillars 71 comprise an inlet oval pillar 71A closer to the inlet body 5 among the inlet body 5 and the outlet body 6, and an outlet oval pillar 71B closer to the outlet body 6 among the inlet body 5 and the outlet body 6

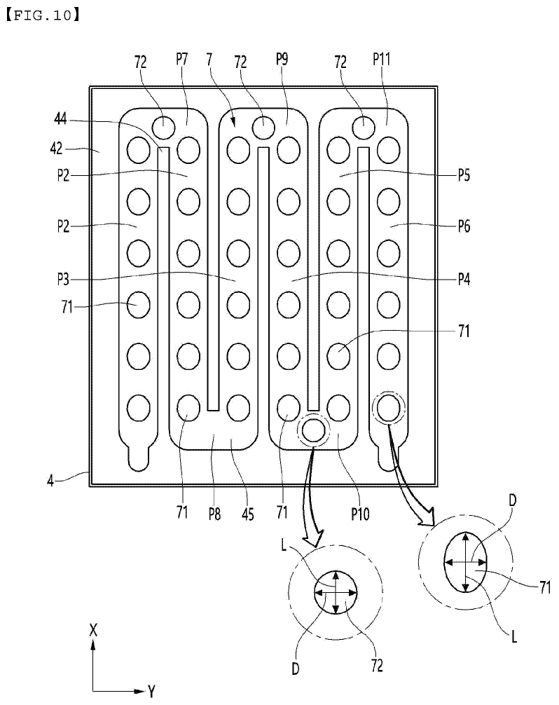

FIG. 9 is a plan view showing the interior of a fourth modified example of a battery heat exchanger according to this embodiment.

The plurality of oval pillars 71 may comprise a unit flow path oval pillar 71C located in a unit flow path and a connection flow path oval pillar 71D located in a connection flow path.

The aspect ratio L/D of the unit flow path oval pillar 71C may be greater than the aspect ratio L/D of the connection flow path oval pillar 71D.

FIG. 10 is a plan view showing the interior of a fifth modified example of a battery heat exchanger according to this embodiment.

The plurality of pillars 7 may comprise an oval pillar 71 having a oval cross-sectional shape and a circular pillar 72 having a circular cross-sectional shape.

The oval pillar 71 may be located in the unit flow path P1, P2, P3, P4, P5, P6.

The circular pillar 72 may be located in the connection passages P7, P8, P9, P10, P11.

The above description is merely illustrative of the technical spirit of the present disclosure, and various modifications and changes can be made by those of ordinary skill in the art, without departing from the scope of the present disclosure.

Therefore, the embodiments disclosed in the present disclosure are not intended to limit the technical spirit of the present disclosure, but are intended to explain the technical spirit of the present disclosure. The scope of the technical spirit of the present disclosure is not limited by these embodiments.

The scope of present disclosure should be interpreted by the appended claims, and all technical ideas within the scope equivalent thereto should be construed as falling within the scope of the present disclosure.

1. A battery heat exchanger comprising:
an upper plate through which heat from the battery is dissipated;
a lower plate having a joint body portion joined to a bottom surface of the upper plate and a flow path body portion forming a flow path through which cooling fluid is guided;
an inlet body guiding cooling fluid to the flow path;
an outlet body which cooling fluid passing through the flow path flows out; and
a pillar positioned in the flow path, protruding from at least one of the upper plate or the lower plate, and having an outer circumference spaced apart from a side wall of the flow path body portion,
wherein a plurality of pillars is formed along the flow path,
wherein at least one of the plurality of pillars is an oval pillar with an oval cross-sectional shape,
wherein the oval pillar is formed to be long in the longitudinal direction of the flow path.

2. The battery heat exchanger of claim 1,
wherein the pillar protrudes from the bottom surface of the upper plate and is in contact with a lower plate portion of the lower plate.

3. The battery heat exchanger of claim 1,
wherein the pillar protrudes from a lower plate portion of the lower plate and is in contact with the bottom surface of the upper plate.

4. The battery heat exchanger of claim 1,
wherein the pillar protrudes from the lower surface of the upper plate and has a lower end spaced apart from a lower plate portion of the lower plate.

5. The battery heat exchanger of claim 1,
wherein an aspect ratio of the oval pillar is greater than 1 and less than or equal to 1.1.

6. The battery heat exchanger of claim 1,
wherein at least one of the plurality of pillars is a porous metal foam.
